(19) United States
(12) Patent Application Publication
(10) Pub. No.: US 2005/0285385 A1
(43) Pub. Date: Dec. 29, 2005

(54) Emergency medical analysis form with detachable patient identification piece and method of using same

(76) Inventors: Antonio V. Bova, Lewis Center, OH (US); Mark D. Thompson, Fredricktown, OH (US)

Correspondence Address: WARD KRAFT, INC., P.O. BOX 938, FORT SCOTT, KS, 66701, US

(21) Appl. No.: 10/878,767

(22) Filed: Jun. 28, 2004

(51) Int. Cl. B42D 15/00

(52) U.S. Cl. 283/75

(57) ABSTRACT

The present invention is a combination business form having first and second parts that are separable from one another one of the parts is used for recording information acquired in an exigent or emergency medical situation and the other part is used to provide at least one detachable patient identification piece such as a wristband, tag or the like. The business form assembly is intended for use by medical triage or paramedic personnel in providing an initial medical diagnosis of a patient and for identifying the patient for subsequent treatment and transporting to a care facility. The form assembly may be provided in a kit arrangement and include additional components such as a sample collection piece, collection tool and the like. In addition, each of the components may be provided with matching indicia so as to facilitate the tracking of the patient or individual during transport, treatment and handling.

### CROSS-REFERENCES TO RELATED APPLICATIONS

None.

### FIELD OF THE INVENTION

The invention of the present specification is found in the field of business forms that have been combined with one or more detachable patient identification pieces. More particularly the subject matter of the invention is directed to a business form combination construction that is intended for use in the medical field, specifically paramedic, exigent or triage applications in which an early analysis is initially made of a patient or victim such that subsequent treatment personnel encountering the patient will be provided the with the benefit of the preliminary diagnosis to aid in the treatment and caring of the individual. The business form assembly of the instant description is a combination construction which includes one or more separable patient tagging elements to aid in the identification of the individual and a method of using the form in connection with the early treatment of a patient or individual.

### BACKGROUND OF THE INVENTION

Business forms are commonly used in the capturing and conveyance of information and can be found in a number of professions and are used for a variety of applications ranging from accounting, inventory control, merchandising, personnel and employment records, medical, archival and a whole host of other uses. While business forms have found regular and repeated uses in the foregoing activities and many other uses, business forms, due to changes in technology (e.g. processing speeds, imaging equipment, etc.) and demands of users, continue to evolve in an effort to meet the changing landscape of business and personal use in order to provide greater efficiencies for end users.

Business forms are generally known and have historically been used for retaining and conveying information relating to a particular product, service, opportunity or other communication regardless of whether the message has commercial or simply personal foundations. Business forms are produced in many different configurations, for a wide variety of purposes and have evolved through time due to changes in technology, such as, in recent memory, the shift from impact printers to non-impact printers such as laser printers.

Medical business forms have a number of uses in hospitals and other care centers, such as doctor's offices, clinics and the like. Such uses include the collection of general data related to a patient's condition, treatment regime, symptoms and the like, pharmacy documents for inventory and dispensing of medicines, admittance forms, insurance documents and many other uses.

The use of medical forms or the need for medical forms has also found its way into use in medical emergency situations. Emergency response teams or emergency medical teams (“EMTs”), paramedics and other rescue personnel need to record and communicate the condition of a patient when arriving on the scene and provide important information to care professionals when the patient is being transferred to a longer term care or treatment location by the emergency treatment team.

Such emergency treatment forms have commonly provided generic information for the manual input of details such as identification of body portions that may have been injured, blood pressure levels, heart rate, level of consciousness, reflexes and responses and other initial symptoms identification measures. These forms require that the emergency personnel manually imprint information related to the patient or individual's condition and place the form with the patient while the patient is being transported. This information may be pinned or clipped to the individual or placed within clothing, bag or other item that is to accompany the patient to the trauma, treatment or care center. However, as might be expected these forms can become lost during subsequent transporting or handling of the patient.

Another difficulty often encountered in emergency care situation is that the environment in which the patient or individual is located is often difficult to work in and extract the individual from. Patients or individuals may be found in wrecked vehicles, destroyed or partially destroyed buildings, underbrush, forests, rivers and other areas. As such, business forms used in the processing of patients or individuals can be ripped or torn and the information lost when the patient or individual is transported from the scene of the accident or injury to the evacuation vehicle, e.g. ambulance, helicopter, etc.

Identification documents are generally issued upon a request or as part of some sort of statutory mandate or requirement. There has also been a rise in the number of identification documents that are issued at the time of entry, participation or when some other immediate or exigent situation arises. Societal changes have also dictated a need for verifying members of a group, participants or the like so that if an individual is lost or worse, some form of identification is available to assist in the tracking or locating of that person.

Identification devices are also generally widely known and have taken the form of identification cards, wristbands, tags, badges, etc. Such articles generally include an individual's name, potentially a photograph and information relating to the event or criteria for which the individual may be admitted to such an event or the like. Exemplary wristband products are shown in U.S. Pat. Nos. 5,653,472, 5,933,993 and 6,016,618. Examples of identification cards are depicted in U.S. Pat. Nos. 3,068,140, 5,058,926 and 5,320,387.

While such forms have been beneficial in treating and caring for patients, such forms still are not completely effective in tracking and preserving information of patients in that the information can become lost during the transport and handling of the individual. In addition, the forms are often separated on arrival at the care center or hospital so that patient information can be entered, and in situations where a number of patients or individuals are being treated simultaneously, such as in the circumstances of a large accident or catastrophe or the like, matching the information quickly with the patient can be difficult requiring the loss of additional and potentially precious time in rendering confirming analysis or diagnosis so that the treatment and care of the patient can continue.

What is needed therefore is a form that meets the information recordation needs of the emergency personnel as well as tracks the patient and related information through the handling and transportation process so as to overcome the difficulties of separation and loss health care data.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention is a combination medical business form assembly in which a construction is provided that has an information recordation section or portion and a patient identification section or portion. The business form assembly of the present invention is constructed from a weather and tear resistant material and is provided with one or more removable and matching indicia sections to aid in the treatment of the patient through the care system or arrangement.

In one exemplary embodiment of the present invention, an emergency medical treatment combination form, is provided and includes a substantially planar substrate having first and second portions that are connected to one another. The first portion of the construction is adapted to receive patient information related to the initial condition of the individual. The first portion has a first face and a second face with the first face having a number of patient information recordation areas that relate to a condition of a patient. The first portion has top and bottom ends and first and second sides. One of the first and second portion is provided with at least one removable pressure sensitive label.

The medical emergency form of the presently described embodiment is also provided top and bottom ends and first and second sides and is joined to said first portion along one of said sides or ends. The second portion that has an outer section and an inner section, the inner section is separable from the outer section in order to create a patient identification piece.

In a still further exemplary embodiment a triage business form is provided and includes a first part that has front and back faces, first and second sides and top and bottom ends. The first part of the triage business form has a first dimension that includes a longitudinal direction and transverse direction. The first part also has at least one area for immediate diagnosis of a patient and another area for providing treatment information.

Still continuing with a discussion of the presently described embodiment, a second part is provided and has front and back faces, first and second sides and top and bottom ends. The second part of the triage business form is connected to the first part alone one of the sides or ends. The second part has a second dimension that includes a longitudinal direction and a transverse direction. The dimension of the second part is less than the dimension of the first part in one of the longitudinal or transverse directions and preferably in the transverse direction. That is, the second part has the dimension in the longitudinal direction (the lengths of the sides are substantially equal) that is substantially equal to the longitudinal direction of the first part. Whereas, the transverse direction of the first part is longer than the transverse direction (top or bottom end) of the second part.

The second part of the triage business form of this presently described embodiment also includes a detachable patient identification band, but may also include other detachable patient identification pieces or elements such as tags, labels, hang tags, buttons and the like.

Each of the first and second parts as well as the patient identification pieces may be provided with matching indicia, that may be human and/or machine readable information so as to facilitate the tracking and matching of the information to the patient or individual.

In yet a still further exemplary embodiment of the present invention, triage tag and specimen collection piece kit, is provided with a number of component parts. One component is a triage tag that has first and second parts, one of the parts has at least one removable patient identification piece that is selected from a group including bands, tags, labels, buttons and combinations thereof. The first part also has areas that are used for recording emergency patient diagnosis information.

Continuing with a description of the presently described kit embodiment, a specimen collection piece is included which has a relatively rigid portion and an absorbent portion. The absorbent portion is used for collecting a biological specimen. The components of this kit embodiment are held by a container which includes at least one triage tag and the specimen collection piece.

The embodiments described above may also include a second part that has an area that is less than the area of the first part. In addition, a pressure sensitive label as well as other patient identification pieces, including tags, hang tags, buttons, and combinations thereof may be included on one or both parts of the form assembly.

In those examples where the triage form of the present invention includes a specimen collection component, the component will typically have a generally rigid portion and an absorbent portion. The specimen collection component may also include a separate collection tool such as a swab, wipe, cups, syringes and the like.

In each of the foregoing embodiments, each of the form or kit components may be provided, printed or imaged with matching information (human and/or machine readable) so that the components of the form, patient identification and kit may be matched and more readily tracked through the transportation and handling of the patient.

In a yet still further embodiment of the present invention, a method of using a triage form and patient identification band, is described and includes the steps of initially obtaining a triage form and patient identification band. The form has first and second parts with the first part containing at least first and second distinct areas for retaining patient information. The second part has a detachable band.

Next, preliminary condition information is recorded on the first area of the first part of the triage form. Then additional details are described that relate to a patient on the second distinct area of the first part of the triage form. Once information has been recorded on the form, the patient identification band is removed from the second part of the form construction. Patient information is then inserted or written or recorded on the band and then the band is applied to an appendage of the patient. Alternatively, the information could be placed on the band prior to the band being placed on the wrist or appendage of the patient. At least one additional removable patient identification piece may then be separated from the form, such as to label a treatment bag or personal belongings of the patient or the like.

Then the patient with the form, band and at least one additional patient identification piece is transported to a treatment location such as a hospital, care facility or the like. At the treatment location, the information contained on the band and at least the form is matched for purposes of confirmation prior to providing additional treatment to the patient.

The foregoing method may include the further step of collecting a specimen from the patient prior to transporting the patient to the care center for the purposes of evidence retention, screening or testing.

Publications, patents and patent applications are referred to throughout this disclosure. All references cited herein are hereby incorporated by reference.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of the present invention;

FIG. 2 provides an alternate embodiment of the present invention, where the form is included as part of a kit for use by emergency personnel;

FIG. 3 illustrates a side view of the present invention in which a collection element has been provided along with the triage tag;

FIG. 4 shows one exemplary construction of a wristband used in connection with the present invention;

FIG. 4A depicts a further exemplary construction of a wristband that is suitable for use with the present invention; and

FIG. 5 provides a block diagram showing an exemplary method of using the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The present invention represents a complete business form combination that enables the ready recording of patient triage information as well as provide for the identification of the patient for the subsequent treating and transporting of the individual. The assembly is provided with discrete areas for the recordation of details relating to the care of the patient and has one or more detachable elements that can be used for identification, treatment, record keeping and the like. One of the detachable elements is a patient identification band that can be applied to a wrist, ankle, arm, leg or other suitable areas so that the care center taking receipt of the individual can match the triage information with the patient prior to rendering additional care. Each of the components, form, patient identification band, kit components, labels, etc. may also be provided, printed or imaged with matching information (human and/or machine readable indicia) so as to facilitate the tracking and matching of patient information during the subsequent transporting, handling and treatment of the patient.

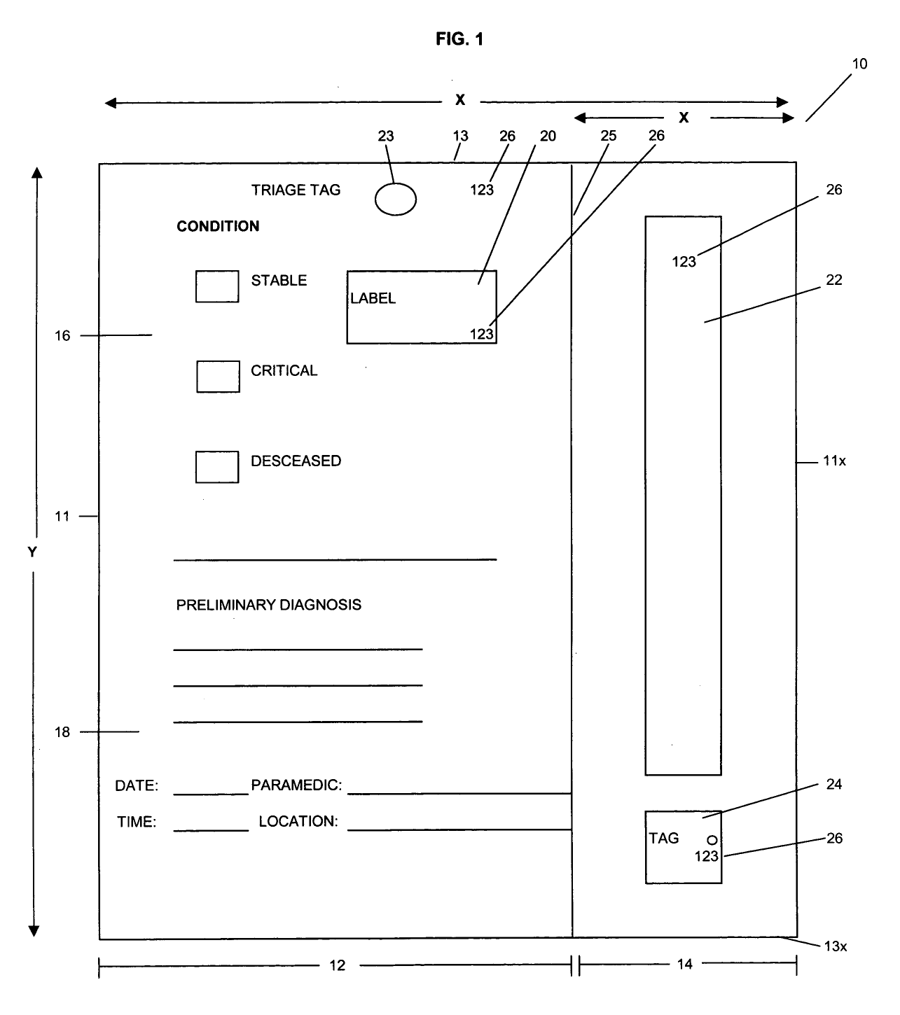

Turning now to a discussion of the exemplary embodiments depicted in the drawings of the present specification, FIG. 1 shows a front view of the triage tag 10. The triage tag 10 includes first and second part 12 and 14. Each of the parts has top and bottom ends and first and second sides which are generally depicted by 11, 11*, 13 and 13*. The sides of each of the parts 12 and 14 have a longitudinal direction designated by the “Y” axis and a transverse axis that is designated by the “X” axis. As can be seen in FIG. 1, the longitudinal axis of the first and second parts 12 and 14 is substantially of equal length whereas the transverse axis, those along the “X” axis are of different lengths, more specifically, the second party 14 has a shorter end edge than the first part 12. It should however be understood that depending on the layout of the form assembly, the second part could be joined to the first part along the transverse axis as opposed to the longitudinal axis as is shown. Generally, however, the second part with the removable patient identification band will need to be attached to the first part along a side or edge that is sufficient to accommodate the length of the band.

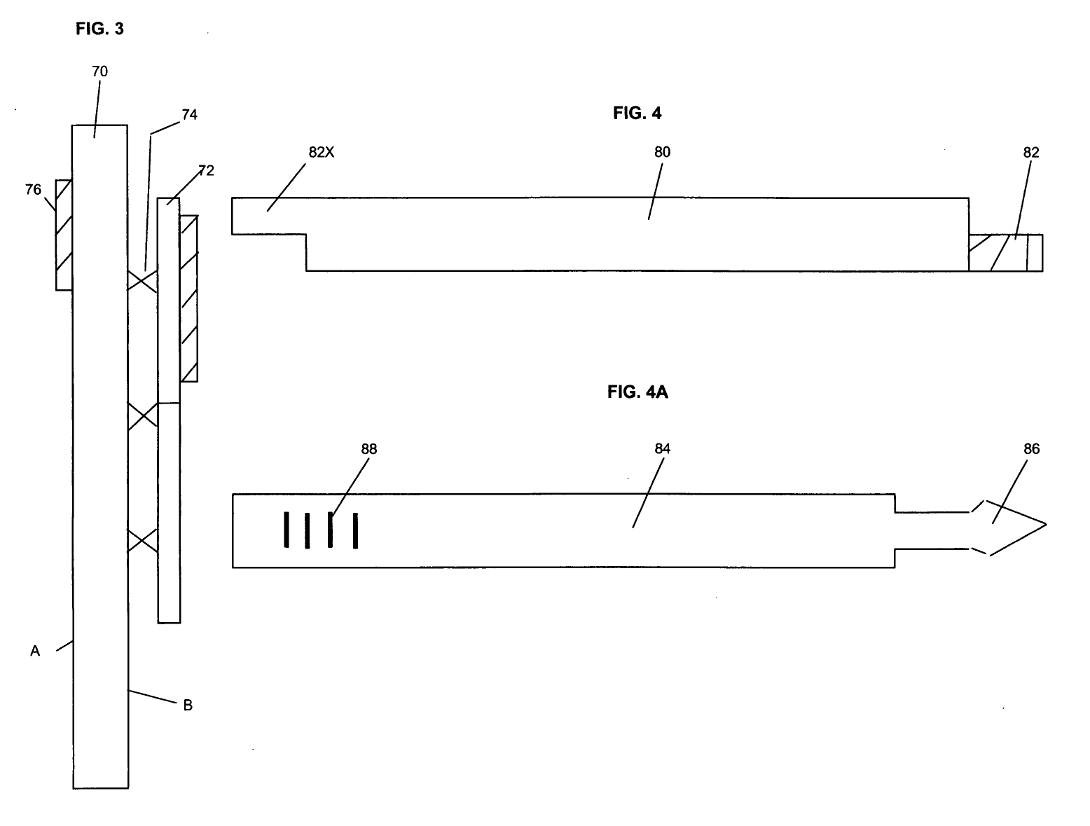

Each of the first and second parts has a first face “A” and a second face “B” (see FIG. 3). As provided in FIG. 1, printing or imaging is provided on at least the first face “A” but it should be understood that the printing or imaging may be provided on either or both of the faces depending on the needs of the end user. For example, one face may be provided with areas for recording and retaining information whereas the second face of the construction may be used to provided instructions for use of the detachable elements (wristband, labels, collection kit, etc.) as well as other areas for recording pertinent information, such as a description of the accident scene, names and numbers of witnesses, etc.

The first part 12 of the triage tag 10 is provided with first and second portions 16 and 18 that are used for recording information about the particular patient or individual. First portion 16 may be used for recording a quick analysis or immediate notification of the condition of the patient and check off boxes for conditions labeled as “stable”, “critical” and “deceased” are provided. The first portion 16 may also be provided with one or more removable labels 20 which are typically a pressure sensitive label that may be removed and placed on IV bags, medical devices, charts and the like to provide necessary information for the treatment of patients.

The second portion 18 of the triage tag 10 is provided with areas for recording additional substantive information such as preliminary diagnosis of a patient, medications provided, physical conditions and the like. In addition, other information may be provided in the second portion 18 such as the date, time, location and names of treatment personnel. As will be readily understood, the first and second portions 16 and 18 of the triage tag 10 may be provided with any sort of information that may be necessary for the care of a patient or that which may be required by local or municipal statutes, codifications and the like.

The triage tag 10 is generally constructed from a synthetic paper that is tear and water resistant. Tear and water resistance is generally preferable as the tag would then not be readily subject to destruction when attempting to remove a patient from the accident scene, such as a vehicle, building, underbrush, river, stream or the like. The first and second portions 16 and 18 of the first part 12 would be printed with information, such as by flash fusion, laser printing, ink jet and thermal (direct thermal and thermal transfer). The image would be UV cured in order to substantially reduce the possibility that the indicia or fields provided would wash off or would be easily removed by rubbing or other contact with the printed fields. The first part may also be provided with a cut out 23 such that the form can be hung or displayed from the patient transport cart to further alert subsequent personnel to the condition of the individual.

The second part 14 of the triage tag 10 as shown in FIG. 1 is provided with a removable patient identification band 22, such as a wristband, ankle band or the like. The second part 14 may also be provided with additional removable patient identification elements, such as a tag 24.

The first and second parts 12 and 14 are joined to one another in an adjacent configuration and are separable or detachable from one another such as through the use of a line of weakness, score line, perforation line and the like.

As can be seen from FIG. 1, each of the components of the triage tag 10, namely the first part 12, patient identification band 22, label 20 and tag 26 are provided with matching indicia 26. As shown, the indicia 26 is represented as numerical indicia “123” which would be human readable. However, it should be appreciated that the indicia 26 may be alpha or numeric information or may be machine readable such as with a bar code. Alternatively, the indicia could be replaced with an RFID tag such that each piece could be tracked without the necessity of scanning or reading.

The indicia 26 is used to facilitate the matching of each of the pieces of the form assembly so as to facilitate the tracking of the individual or patient as the patient is transferred from location to location and treatment information or medication given to the patient is confirmed prior to engaging in further care to preserve the patient and condition.

Construction of the form assembly of the present invention is relatively straight forward and will be readily understood by those with skill in the art. Initially, the base stock provided with some preliminary printing, perforating of the line of weakness 25 and punching any holes that may be required in the form, such as hole 23 that enables the form to be used as hang tag is performed. Then any removable labels, such as pressure sensitive latex stock, are printed and are applied to the form assembly. The form assembly with the label(s) applied may then be imaged, bar coded, through a laser printer, flash fusion process, ink jet and thermal printing. The stock is cut or trimmed to the size necessary if excess material is present.

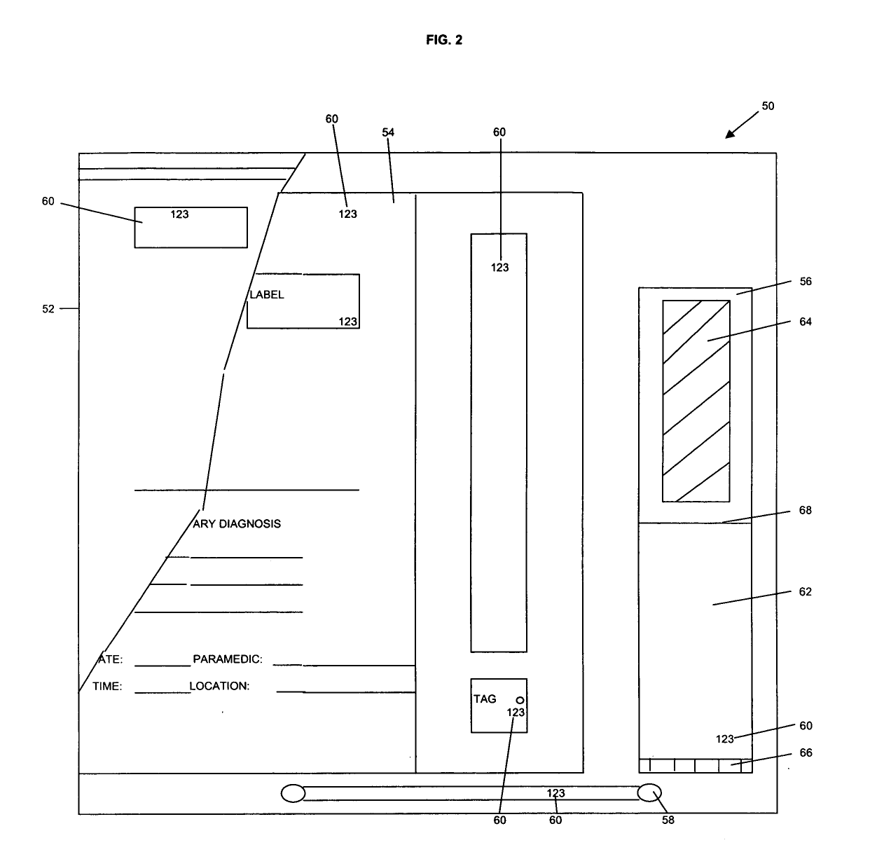

Reference is now directed to FIG. 2 of the present invention in which an alternative embodiment is provided. A kit, generally designated by reference to numeral 50 is provided. The kit 50 includes a container 52, here a plastic bag, that is sized and configured to hold at least one triage form 54, collection piece 56 and collection tool 58. As can be seen from FIG. 2, each element of the kit is provided with matching indicia 60 so that each piece of the kit and the integrity of the kit can be maintained as well as to aid in the tracking and treatment of the patient as has been previously described. The container 52 is shown in a cut away configuration such that each element contained within the kit is visible for the purposes of this discussion.

While a plastic bag has been discussed in the present embodiment, it should be understood that any suitable structure may be used such as an envelope, box, sleeve, tube or the like. In addition, a kit may comprise a series of envelopes, bags, and the like being inserted in a larger container or kit for distribution to one or more agencies that would used the kit in connection with its recovery efforts.

Continuing to refer to FIG. 2, the collection piece is generally constructed of a rigid element 62, which may be a card stock, plastic strip or the like. The collection piece 56 will preferably be provided with a sample collection area 64 which preferably will be an absorbent material such as gauze, absorbent fibers or the like. The collection area 64 may also be an absorbent patch so as to capture a finger print or the like. The collection piece 56 may also have a closure element 66 which could be for example a pressure sensitive adhesive such that when the rigid element 62 is folded about fold line 68 the collection piece 56 can be sealed with the sample relatively retained within the collection piece.

Also shown in FIG. 2 is a collection tool 58, such as a swab which has absorbent ends for use in collecting a biological specimen (saliva, seamen, etc.) and then applying it to the absorbent pad 64 of the collection piece 56.

Turning now to FIG. 3 of the present invention in which a side view of the triage form 70 is provided showing a further alternative construction of the present invention. The triage form 70 has a collection piece 72 (the structure of which was previously described in connection with FIG. 2) that is removably, adhesively attached by spots, patterns or the like of adhesive 74. The collection piece 72 is attached to one face of the form construction 70, and preferably to the side of the form that is not intended to record treatment information of the patient. In this embodiment, the collection piece 72 may not be utilized by the triage or paramedic personnel and the collection piece can simply remain with the form assembly and not be used. If however, the situation calls for use of the collection piece 72, the paramedic or other personnel would simply peel off the collection piece, collect a sample and either retain it for evidentiary or matching reasons or submit it along with the patient for testing at the care facility.

Also shown in FIG. 3 is at least one removable tag or label 76 that will be typically blown on or tipped on the exterior or face of the form.

Reference is now directed to FIGS. 4 and 4A in which two exemplary constructions for use a patient identification bands are provided. In FIG. 4, a self laminating band is provided which includes opposed ends or tabs 82 and 82* with at least one of which, 82, is provided with an adhesive so as to enable closure and sealing of the band about an appendage of the patient or individual.

In FIG. 4A a further illustration is provided in which band 84 is provided with a male end 86 and a female end 88 or a slot and tab configuration in which the tab or male end 86 is inserted into the slot or female end 88 when the band is secured around the patient's appendage. A series of slots 88 may be provided so that the band can be sized to the particular individual.

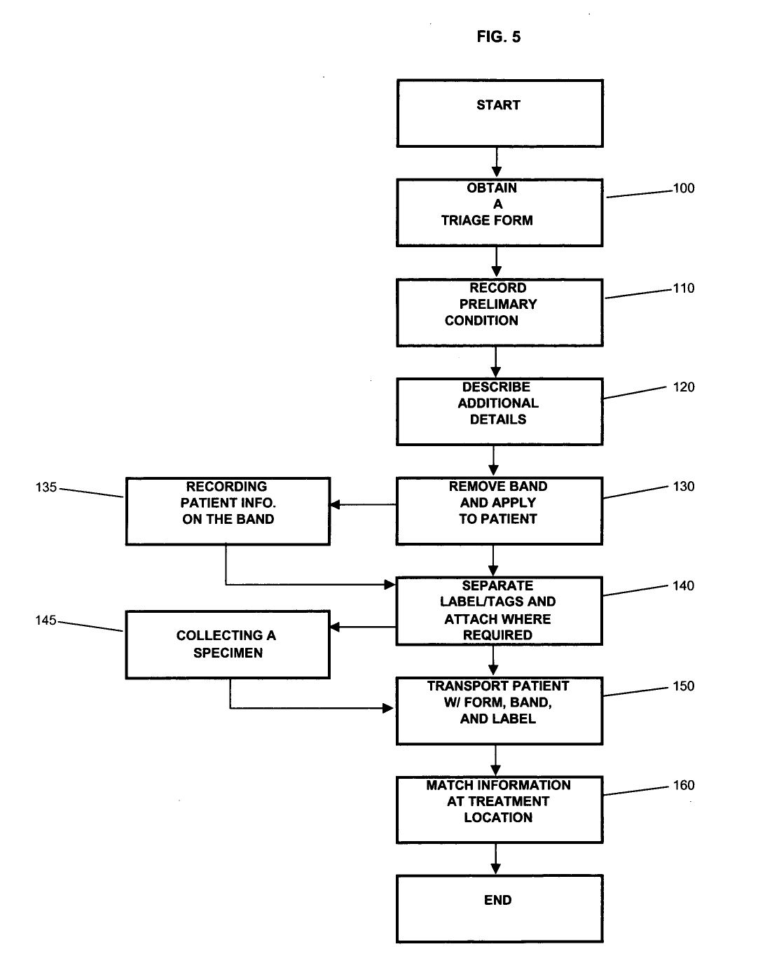

Turning now to FIG. 5, an exemplary method of using the present invention is described. In use, the paramedic or other emergency personnel arrive at an accident scene or other location to which they have been summoned to treat or care for an individual that has been injured or needs assistance, such as in the situation of a cardiac arrest. The paramedic will retrieve the form of the present invention either from a kit as provided in FIG. 2, or use a form as described in either embodiment of FIG. 1 or FIG. 3 at step 100.

The paramedic will take an initial or preliminary diagnosis of the situation and record information related to the person, such information may include “stable”, “critical” or “deceased” or other diagnosis that may be required at step 110. The paramedic will also record information relating to the condition of the person or individual as well as record information pertaining to the location and other details that are necessary to track the call for which the paramedic was summoned at step 120.

Next, the paramedic will separate the band from the form portion at step 130. It should be understood that while the second part of the form construction as described herein is fully separable from the construction, the band may be removed from the second part without the necessity of removing the second part. Information relating to the patient, such as name or other identifying details are added or inserted on the band at step 135 and the band is applied to an appendage of the patient. The information to be applied to the band may be done either before or after the band has been removed from the form.

At least one other patient identification piece is then removed from the form, either the first or second part, at step 140. This identification piece may be a tag, label, button, hang tag or the like and may be attached to a treatment device that is to accompany the patient, i.e. IV bag, monitor, etc. or could be attached to a personal belonging, i.e. purse, so that the item can again be associated with the patient at a later time.

Once the identification and early analysis and diagnosis is done, the patient is transported to the care facility at step 150. Prior to transport, and if necessitated by the circumstances or requirements for treatment, a biological specimen can be collected through use of a sample collection piece at step 145.

Upon reaching the care facility, each of the components are then matched to ensure conformity and to check medications, identity, etc. of the patient at step 160 prior to further treatment.

It will thus be seen according to the present invention a highly advantageous emergency medical and patient identical form has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. An emergency medical treatment combination form, comprising;
a substantially planar substrate having first and second separable portions;
said first portion adapted to receive patient information, said first portion having a first face and a second face, said first face having a number of patient information recordation areas relating to a condition of a patient, and said first portion having top and bottom ends and first and second sides; and
said second portion having top and bottom ends and first and second sides, said second portion is connected to said first portion along one of said ends or sides, said second portion having an outer section and an inner section, said inner section is separable from said outer section in order to create a patient identification piece.

2. An emergency medical treatment combination form as recited in claim 1, wherein said inner section forms a wrist band having first and second ends and that has at least one exposed adhesive part to connect said ends together about a patient's wrist, arm, leg or ankle.

3. An emergency medical treatment combination form as recited in claim 1, wherein said first and second portion are constructed from a material that is tear and water resistant.

4. An emergency medical treatment combination form as recited in claim 1, wherein one of said first and second portions is provided with at least one removable pressure sensitive label.

5. An emergency medical treatment combination form as recited in claim 1, wherein said second portion is provided with a second patient identification piece.

6. An emergency medical treatment combination form as recited in claim 5, wherein said second identification piece is selected from a group including a tag, label, button, hang tag, card and combinations thereof.

7. An emergency medical treatment combination form as recited in claim 1, wherein said first portion has a dimension including a longitudinal direction and a transverse direction and said second portion has a dimension including a longitudinal direction and a transverse direction one of which is less than said longitudinal direction and transverse direction of said dimension of said first portion.

8. An emergency medical treatment combination form as recited in claim 1, wherein said form further includes a detachable specimen collection component.

9. An emergency medical treatment combination form as recited in claim 1, wherein the patient identification piece and first part are provided with matching indicia to facilitate tracking and matching.

10. A triage business form, comprising;
a first part having front and back faces, first and second sides and top and bottom ends, said first part having a first dimension including a longitudinal direction and transverse direction and including at least one area for immediate diagnosis of a patient and another area for providing treatment information;
a second part having front and back faces, first and second sides and top and bottom ends, said second part is connected to said first part alone one of said sides or ends, said second part having a second dimension including a longitudinal direction and a transverse direction, said second dimension is less than said first dimension in one of said longitudinal or transverse directions and said second part including a detachable patient identification band; and
each of said first and second parts is provided with matching indicia for tracking and matching of information.

11. A triage business form as recited in claim 10, wherein said second dimension of said second part is less than said first dimension along said transverse direction.

12. A triage business form as recited in claim 10, wherein said second dimension of said second part is less than said first dimension along said longitudinal direction.

13. A triage business form as recited in claim 10, wherein said first and second parts are formed from a tear resistant material.

14. A triage business form as recited in claim 10, wherein said first part includes at least one removable pressure sensitive label.

15. A triage business form as recited in claim 10, wherein said second part includes a second detachable patient identification piece selected from a group including tags, labels, hang tags, buttons and combinations thereof.

16. A triage business form as recited in claim 10, wherein said triage business form includes a detachable specimen collection component.

17. A triage business form as recited in claim 10, wherein said patient identification band is provided with a fastening element selected.

18. A triage tag and specimen collection piece kit, comprising;
a triage tag including first and second parts, one of said parts including at least one removable patient identification pieces selected from a group including bands, tags, labels, buttons and combinations thereof, said first part including emergency patient diagnosis information areas;
a specimen collection piece including a relatively rigid portion and an absorbent portion, said absorbent portion for collecting a biological specimen; and
a container for holding at least one triage tag and said specimen collection piece.

19. A kit as recited in claim 18, wherein said kit further includes a specimen collector selected from a group including swabs, syringes, wipes, cups and combinations thereof.

20. A kit as recited in claim 18, wherein each of said triage tag, patient identification piece and collection piece is provided with matching indicia to enable tracking and matching of information.

21. A kit as recited in claim 18, wherein said container is a plastic bag.

22. A method of using a triage form and patient identification band, comprising the steps of;
obtaining a triage form and patient identification band, said form having first and second parts with said first part containing at least first and second distinct areas for retaining patient information and said second part having a detachable band;
recording preliminary condition on said first area of said first part of said triage form;
describing additional details relating to a patient on said second distinct area of said first part of said triage form;
removing said patient identification band from said second part and inserting patient information on said band and applying said band to the patient;
separating at least one additional removable patient identification piece from said form;
transporting the patient with said form, band and at least one additional patient identification piece to a treatment location; and
matching information contained on said band and at least said form for confirmation prior to providing additional treatment.

23. A method as recited in claim 22, including a further step of collecting a biological specimen with a specimen collection piece prior to the step of transporting the patient.
